(19) United States
(12) Patent Application Publication
(10) Pub. No.: US 2008/0310172 A1
(43) Pub. Date: Dec. 18, 2008

(54) Laser diode attachment holder

(75) Inventor: Aiichiro Ikeda, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 12/155,909

(22) Filed: Jun. 11, 2008

(30) Foreign Application Priority Data
Jun. 12, 2007 (JP) P2007-155565

(51) Int. Cl. F21V 19/00; A44B 19/42

(52) U.S. Cl. 362/382; 156/66

(57) ABSTRACT

A step portion is disposed at the periphery of a position where the adhesive is applied so that a front end of a needle for ejecting the adhesive comes in contact with the step portion. A passage is formed in the step portion so as to introduce the adhesive ejected from the front end of the needle to the position.

The disclosure of Japanese Patent Application No. 2007-155565 filed on Jun. 12, 2007 including specification, drawings and claims is incorporated herein by reference in its entirety.

The present invention relates to a laser diode attachment holder attached with a laser diode for an optical pickup, and more particularly, to a laser diode attachment holder to which a laser diode is attached by applying an adhesive thereto.

In the past, a technique is known in which a semiconductor laser element (laser diode) used as a light source of an optical pickup is positioned to be inserted to an attachment hole of a holder portion (laser diode attachment holder) made of an aluminum diecast and then a thermal emissive adhesive is injected into an injection hole of the holder portion so that the semiconductor laser element is attached to the holder portion (for example, see Patent Document 1).

FIG. 5 is a top plan view illustrating a laser diode attachment holder 10 (hereinafter, referred to as ‘holder’) attached with a laser diode 100 according to a known example. The holder 10 shown in the same drawing is made of metal, and the laser diode 100 which is positioned to be inserted to an attachment hole 12 is bonded to be fixed to the holder 10 by an adhesive 20 which is applied to several points in the vicinity thereof.

Positions in which the adhesive 20 is applied are regulated by concave portions 30 provided in flat outer surfaces of the holder 10, and the adhesive 20 injected into the concave portions 30 is bonded to the wall surfaces of the concave portions 30 or the outer surfaces of the laser diode 100, thereby allowing the laser diode 100 to be bonded and thus fixed to the holder 10 as described above.

FIG. 6 is a sectional view explanatorily illustrating a main part during a process in which the adhesive 20 is injected into the concave portion 30 of the holder 10 (an adhesive injection process). As it may be understood from the same drawing, in the adhesive injection process, a front end 41 of a narrow needle 40 mounted to an adhesive injection jig T is allowed to face the concave portion 30 in an inclined direction from a side position adjacent to the laser diode 100 which is temporarily fixed to an attachment hole 12 of the holder 10. In such a state, a predetermined amount of adhesive ejected from the front end 41 of the needle 40 is injected into the concave portion 30 in the direction indicated by the arrow a.

Patent Document 1: Japanese Patent Publication 2004-171627A

However, when the adhesive injection process is manually carried out, a problem may arise in that the front end 41 of the needle held in an operator's hand contacts with the laser diode 100 before the adhesive injection process, during the adhesive injection process, or after the adhesive injection process. At this time, when the front end 41 of the needle 40 contacts with the laser diode 100, positional precision of the laser diode 100 which is positioned to be temporarily fixed to the attachment hole 12 of the holder 10 deteriorates. Meanwhile, in an optical pickup, a problem may arise in that recording performance or reproducing performance deteriorates due to a positional deviation of an optic axis of the laser diode 100. For this reason, it is desirable to prevent the above-described case that the front end 41 of the needle 40 contacts with the laser diode 100 to thereby deteriorate positional precision.

### SUMMARY

It is therefore an object of at least one embodiment of the present invention to provide a laser diode attachment holder that is designed to prevent a case that positional precision of the laser diode deteriorates and to improve workability of an adhesive injection process by regulating a needle which is held in an operator's hand not to contact with a laser diode before the adhesive injection process, during the adhesive injection process, or after the adhesive injection process so that the front end of the needle is prevented from contacting with the laser diode in advance even when the adhesive injection process is manually carried out.

In order to achieve the above objects, according to an aspect of at least one embodiment of the present invention, there is provided a laser diode attachment holder to which a laser diode is bonded and fixed with an adhesive, the laser diode attachment holder comprising: a step portion disposed at the periphery of a position where the adhesive is applied so that a front end of a needle for ejecting the adhesive comes in contact with the step portion, wherein a passage is formed in the step portion so as to introduce the adhesive ejected from the front end of the needle to the position.

With such a configuration, when the adhesive injection process is manually carried out, a position of the needle is regulated so as not to contact with the laser diode just by an operation in which the operator allows the front end of the needle to come into contact with the step portion while holding the jig mounted with the needle in the operator's hand. Then, when the adhesive is ejected from the needle in a state that the front end of the needle comes into contact with the step portion, the adhesive is injected into an application position through the passage of the step portion. After the adhesive injection process, the front end of the needle is made away from the step portion. As a result, according to the invention, it is possible to prevent a case that the front end of the needle contacts with the laser diode before the adhesive injection process, during the adhesive injection process, or after the adhesive injection process to thereby deteriorate positional precision. Also, it is possible to improve workability of the adhesive application process.

A step portion may be formed by a wall portion of a recess to which the needle is fittable. With such a configuration, since the needle is fitted to the recess in a state that the front end comes into contact with the step portion, it is possible to prevent a case that the needle is slid aside thereby interrupt a smooth injection during the adhesive injection process. For this reason, the operator who carries out the adhesive injection process can improve workability and carry out the adhesive injection process with a little skill.

The needle fitted to the recess may be interposed between wall surfaces of the recess so as to be positioned in a diameter direction thereof. With such a configuration, since the needle is fitted to the recess in a state that the front end comes into contact with the step portion, it is possible to improve precision of the adhesive injection process. This effect is more apparently exhibited by adopting a configuration in which a size and a position of the passage is set so that an ejection nozzle of the front end of the needle faces the passage when the needle fitted to the recess is interposed between the wall surfaces of the recess to be positioned in the diameter direction thereof.

A bottom surface of the recess may be downwardly inclined toward the step portion; and the passage may be a groove formed in the step portion. With such a configuration, since the ejection nozzle of the front end of the needle faces the adhesive application position in an inclined direction just by allowing the needle to slide on the inclined surface forming the bottom surface of the recess, it is possible to easily and accurately carry out the adhesive injection process without a skill.

A width of the passage may be narrower than an outer diameter of the front end of the needle. A width of the passage may be substantially equal to a diameter of the ejection nozzle of the front end of the needle. An extending direction of the wall portion to which the needle is fittable may be inclined with respect to an extending direction of the recess. Alternatively, an extending direction of the wall portion to which the needle is fittable may be perpendicular to an extending direction of the recess.

According to another aspect of at least one embodiment of the present invention, there is provided a method for attaching a laser diode to a laser diode attachment holder with an adhesive, comprising: mounting the laser diode on the laser diode attachment holder; fitting a front end of a needle for ejecting the adhesive to a step portion disposed at the periphery of a position adjacent to the mounted laser diode; and ejecting the adhesive from the front end of the needle to the position through a passage which is formed in the step portion so that the laser diode is bonded and fixed to the laser diode attachment holder.

As described above, according to the laser diode attachment holder and the method for attaching the laser diode to the laser diode attachment holder, it is possible to prevent the needle mounted to the jig which is held in an operator's hand can be regulated not to contact with the laser diode before the adhesive injection process, during the adhesive injection process, or after the adhesive injection process even when an adhesive injection process is manually carried out. Thus, the front end of the needle is prevented from contacting with the laser diode in advance, thereby preventing a case that positional precision of the laser diode deteriorates. Accordingly, it is possible to easily and accurately carry out the adhesive injection process. As a result, it is advantageous in that productivity can be improved and deterioration in recording performance or reproducing performance of an optical pickup due to a positional deviation of the optic axis can be prevented, the optical pickup being configured such that the laser diode is attached to the laser diode attachment holder. In addition, the laser diode attachment holder according to the invention can be configured such that a step portion with a recess or a passage is attached to the concave portion of the holder which is described with reference to FIG. 5 and the like. As a result, it is advantageous in that product cost does not increase to prepare additional components.

### BRIEF DESCRIPTION OF THE DRAWINGS

The above objects and advantages of the present invention will become more apparent by describing in detail exemplary embodiments thereof with reference to the accompanying drawings, wherein:

FIG. 1 is a top view illustrating a holder according to an embodiment of the invention;

FIG. 2 is a top view partly illustrating a state that an adhesive is injected into the holder according to the embodiment;

FIG. 3 is a side view illustrating the state that the adhesive is injected into the holder according to the embodiment;

FIG. 4 is a top view illustrating the holder according to a modified example;

FIG. 5 is a top view illustrating the holder according to a known example;

FIG. 6 is a sectional view illustrating a main part in a state that an adhesive is injected into the holder according to the known example; and

FIG. 7 is a top view illustrating a state that an adhesive is injected into the holder according to another embodiment.

### DETAILED DESCRIPTION OF THE EMBODIMENTS

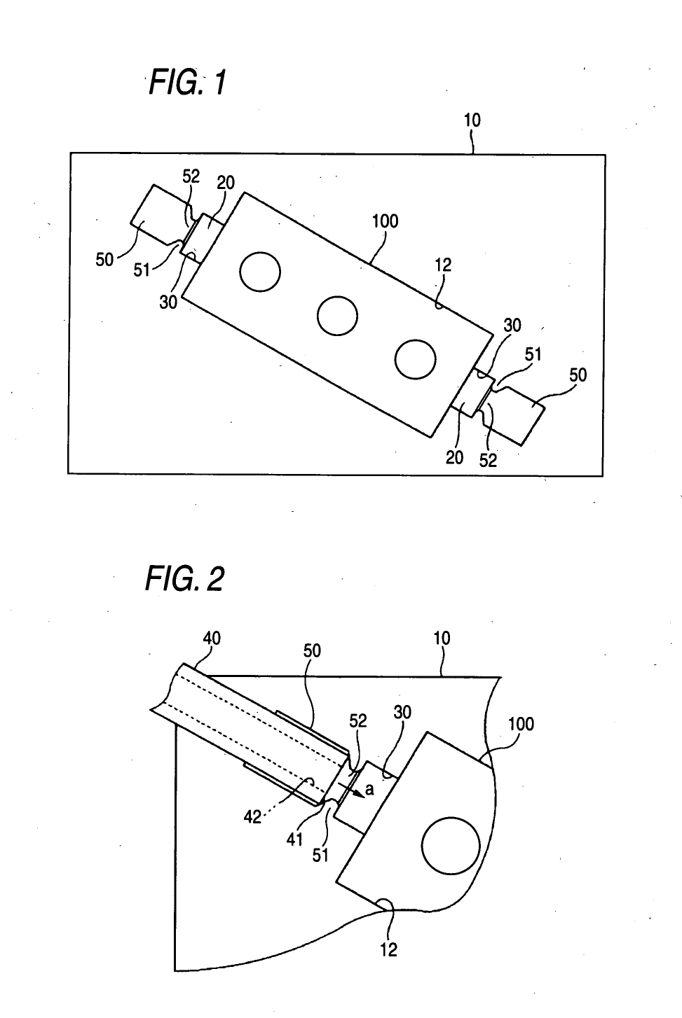

FIG. 1 is a top view illustrating a holder 10 attached with a laser diode 100 according to an embodiment of the invention. In the same drawing, the holder 10 is made of metal, and a laser diode 100 which is positioned to be inserted to an attachment hole 12 is bonded to be fixed to the holder 10 by an adhesive 20 which is applied to several points in the vicinity thereof.

An application position of an adhesive 20 is regulated by each of concave portions 30 which are provided in flat outer surfaces of the holder 10, and then the adhesive 20 which is injected into the concave portions 30 is attached to wall surfaces of the concave portions 30 or the outer surface of the laser diode 100, thereby fixing the laser diode 100 to the holder 10.

As it may be understood from FIG. 1, in this embodiment, each of recesses 50 is formed in the holder 10 on the side opposite to the attachment position of the laser diode 100 with the concave portion 30 interposed therebetween so as to extend in a direction away from the concave portions 30. Then, a wall portion of the recess 50 which separates the recess 50 from the concave portion 30 corresponds to a step portion 51, and a groove-shaped passage 52 is formed in the step portion 51. Accordingly, the recess 50 communicates with the concave portion 30 through the narrow passage 52. In addition, the recess 50 has a width that a needle 40 (which is described below) can be fitted thereto. A groove width of the groove which forms the passage 52 is set to be smaller than an outer diameter of a front end 41 of the needle 40. The width of the passage 52 is set to be substantially the same as a diameter of an ejection nozzle of the front end 41 of the needle 40. Accordingly, the front end of the needle 40 which is inserted to the recess 50 can come into contact with the step portion 51. Further, a total amount of adhesive ejected from the ejection nozzle of the needle 40 is injected into the concave portion 30 through the passage 52.

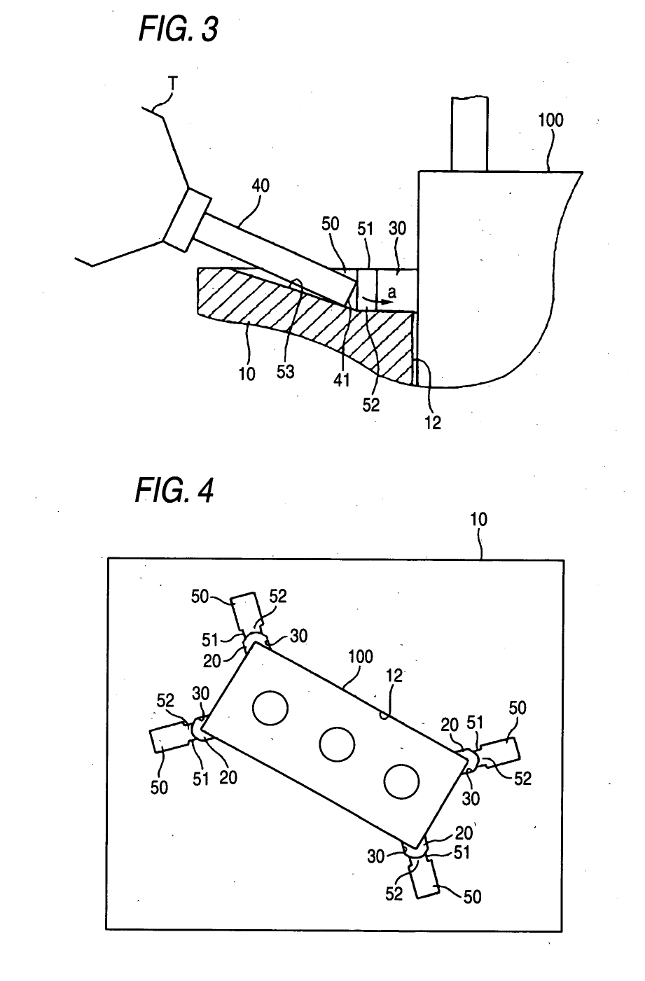

FIG. 2 is a top plan view partly illustrating a state that an adhesive is injected into the laser diode attachment holder 10 with the configuration described with reference to FIG. 1. FIG. 3 is a side view partly illustrating the same state.

As it may be understood from FIG. 2 or 3, in an adhesive injection process, an operator holds an adhesive injection jig T in the operator's hand, and then the operator allows the front end 41 of the narrow needle 40 which is mounted to the jig T to face the concave portion 30 in an inclined direction from a side position adjacent to the laser diode 100 which is positioned to be temporarily fixed to an attachment hole 12 of the holder 10. In such a state, a predetermined amount of adhesive ejected from the front end 41 of the needle 40 is injected into the concave portion 30 in the direction indicated by the arrow a.

In such an adhesive injection process, the front end 41 of the needle 40 faces the concave portion 30 in an inclined direction just by an operation in which the needle 40 of the jig T which is held in the operator's hand is inserted to the recess 50 to allow the front end 41 to come into contact with the step portion 51 before injecting an adhesive. Then, when a predetermined amount of adhesive is ejected from the ejection nozzle 42 of the front end 41 of the needle 40 in a state that the front end 41 of the needle 40 comes into contact with the step portion 51, the adhesive is injected into the concave portion 30 through the groove-shaped passage 52 in the direction indicated by the arrow a. After injecting the adhesive, the front end 41 of the needle 40 becomes away from the step portion 51. Accordingly, in the adhesive injection process, a problem that the needle 40 comes in contact with the laser diode 100 before injecting the adhesive or after injecting the adhesive to thereby deteriorate positional precision of the laser diode 100 does not occur. As a result, although the operator can carries out the adhesive injection process without a skill, the adhesive is easily and accurately injected into the concave portion 30, thereby improving productivity. Additionally, it is possible to prevent deterioration in recording performance or reproducing performance of an optical pickup, which is configured by the laser diode 100 attached to the holder 10, due to a positional deviation of the optic axis.

In the above-described configuration, when the width of the recess 50 is set to be approximately the same as that of the outer diameter of the needle 40, the needle 40 fitted to the recess 50 is inserted to the wall surface of the recess 50 to be positioned thereto in a diameter direction, and thus it is advantageous in that the direction of the needle 40 is easily and accurately set. Additionally, when the size and the position of the passage 52 is set so that the ejection nozzle 42 of the front end 41 of the needle 40 faces the passage 52 in a state that the needle 40 fitted to the recess 50 is interposed between the wall surfaces of the recess 50 to be positioned thereto in the diameter direction, it is possible to more accurately inject the adhesive into the concave portion 30 through the passage 52.

As shown in FIG. 3, in this embodiment, the bottom surface 53 of the recess 50 is formed by an inclined surface which is inclined downward toward the step portion 51. Accordingly, it is advantageous in that the ejection nozzle 42 (see FIG. 2) of the front end 41 of the needle 40 can easily face the concave portion 30 in an inclined direction just by allowing the needle 40 to slide on the bottom surface 53.

In the holder 10 shown in FIG. 1, although the concave portions 30, which correspond to adhesive application positions, are formed in both sides with the laser diode 100 interposed therebetween, the positions where the concave portions 30 are formed may be appropriately modified in consideration of the shape and the size of the laser diode 100. For instance, as shown in FIG. 4, the concave portions 30 are formed as many as the four corners of the angular laser diode 100, the recesses 50 are attached to the concave portions 30, and then the groove-shaped passages 52 are formed in the step portions 51 which are formed by the wall portions of the recesses 50. With this configuration, the laser diode 100 can be more firmly fixed to the holder 10.

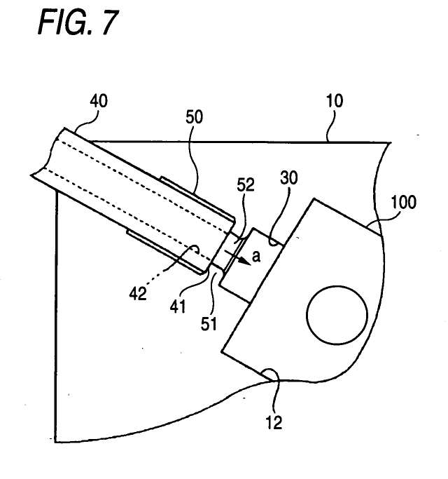

In the above described embodiments, as shown in FIG. 2, an extending direction of the wall portion of the step portion 51 is inclined with respect to an extending direction of the recess 50. This configuration facilitates the injection of the adhesive 20 into the concave portion 30 through the passage 52. However, the extending direction of the wall portion of the step portion 51 may be perpendicular to the extending direction of the recess 50 as shown in FIG. 7. With this configuration, since the front end of the needle 40 which is inserted to the recess 50 can come into close contact with the wall portion of the step portion 51. Therefore, the adhesive is prevented from remaining in a space formed between the front end of the needle 40 and the wall portion of the step portion 51.

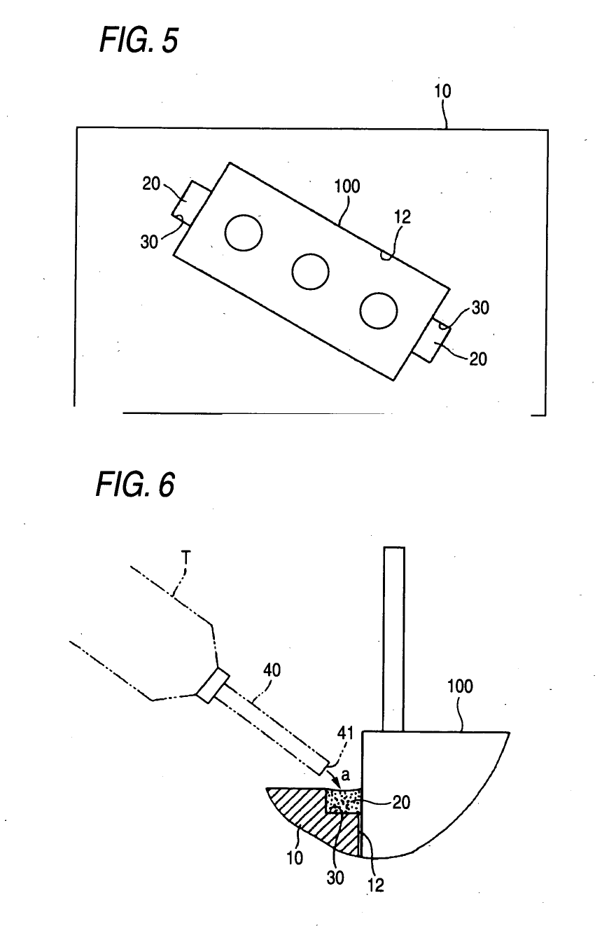

Additionally, in FIGS. 1 to 6, the same reference numerals are given to the same components or the corresponding components.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A laser diode attachment holder to which a laser diode is bonded and fixed with an adhesive, the laser diode attachment holder comprising:
a step portion disposed at the periphery of a position where the adhesive is applied so that a front end of a needle for ejecting the adhesive comes in contact with the step portion,
wherein a passage is formed in the step portion so as to introduce the adhesive ejected from the front end of the needle to the position.

2. The laser diode attachment holder as set forth in claim 1, wherein a step portion is formed by a wall portion of a recess to which the needle is fittable.

3. The laser diode attachment holder as set forth in claim 2, wherein the needle fitted to the recess is interposed between wall surfaces of the recess so as to be positioned in a diameter direction thereof.

4. The laser diode attachment holder as set forth in claim 3, wherein a size and a position of the passage is set so that an ejection nozzle of the front end of the needle faces the passage when the needle fitted to the recess is interposed between the wall surfaces of the recess to be positioned in the diameter direction thereof.

5. The laser diode attachment holder as set forth in claim 4,
wherein a bottom surface of the recess is downwardly inclined toward the step portion; and
wherein the passage is a groove formed in the step portion.

6. The laser diode attachment holder as set forth in claim 5, wherein a width of the passage is narrower than an outer diameter of the front end of the needle.

7. The laser diode attachment holder as set forth in claim 5, wherein a width of the passage is substantially equal to a,diameter of the ejection nozzle of the front end of the needle.

8. The laser diode attachment holder as set forth in claim 2, wherein an extending direction of the wall portion to which the needle is fittable is inclined with respect to an extending direction of the recess.

9. The laser diode attachment holder as set forth in claim 2, wherein an extending direction of the wall portion to which the needle is fittable is perpendicular to an extending direction of the recess.

10. A method for attaching a laser diode to a laser diode attachment holder with an adhesive, comprising;
mounting the laser diode on the laser diode attachment holder;
fitting a front end of a needle for ejecting the adhesive to a step portion disposed at the periphery of a position adjacent to the mounted laser diode; and
ejecting the adhesive from the front end of the needle to the position through a passage which is formed in the step portion so that the laser diode is bonded and fixed to the laser diode attachment holder.
